(19) United States
(12) Patent Application Publication
(10) Pub. No.: US 2026/0168643 A1
(43) Pub. Date: Jun. 18, 2026

(54) PROJECTION LAMP ASSEMBLY, EXTERIOR REAR-VIEW ASSEMBLY

(71) Applicant: MOTHERSON INNOVATIONS COMPANY LIMITED, London (GB)

(72) Inventors: Shahad ALGURABI, Lonsdale (AU); Sam PEACOCK, Lonsdale (AU); Matthew CHAPMAN-WINTER, Lonsdale (AU); Andrew MURRAY, Lonsdale (AU)

(21) Appl. No.: 19/416,227

(22) Filed: Dec. 11, 2025

(30) Foreign Application Priority Data
Dec. 17, 2024 (DE) 102024138313.5

(51) Int. Cl. F21S 43/20

(52) U.S. Cl. CPC F21S 43/2605

(57) ABSTRACT

The present disclosure provides projection lamp assembly to be mounted on a vehicle, the projection lamp assembly comprising: a casing, a light system, at least one lens system; and at least one mask system. The at least one lens system and the at least one mask system are configured to receive the emitted light from the light system and transmit the received light to illuminate at least two projections, wherein the illumination of each of at least two projections is independent of each other.

### CROSS-REFERENCE TO RELATED APPLICATIONS

This application claims the benefit of German Patent Application No. DE 102024138313.5, filed on Dec. 17, 2024, the content of which is incorporated herein by reference in its entirety.

The present disclosure relates to a projection lamp assembly for or mounted on a vehicle. The present disclosure further relates to an exterior rear-view assembly for a vehicle.

Projection lamp systems for vehicles have evolved significantly in recent years, becoming an integral part of automotive design and brand identity. These systems serve multiple purposes, including enhancing vehicle aesthetics, improving brand recognition, and providing functional illumination for safety and convenience. The increasing demand for vehicle customization and brand differentiation led to further innovations. U.S. Pat. No. 8,757,839 disclosed a system capable of projecting multiple images by using a rotatable mask assembly. This allowed for a change in projected logos or images, albeit through mechanical means.

Advancements in LED technology significantly impacted logo projection systems. US Patent Application Publication 2016/0152180 describes a LED-based logo projector that offers improved energy efficiency and durability compared to earlier halogen-based systems.

The integration of logo projection with other vehicle systems also became a focus of innovation. For instance, U.S. Pat. No. 10,023,100 presents a method of coordinating logo projection with vehicle locking systems, enhancing the welcome and goodbye experience for users.

As vehicles became more technologically sophisticated, there was a push towards dynamic and programmable logo projection. US Patent Application Publication 2018/0111549 describes a system capable of projecting animated or changing logos using digital light processing (DLP) technology.

Despite these advancements, most existing systems still face limitations. Many are confined to projecting a single image at a time or require complex mechanical systems to switch between multiple images. Others lack the ability to independently control multiple projections, limiting their versatility.

Moreover, the increasing focus on vehicle safety has led to explorations of using logo projections for communication with pedestrians and other road users. US Patent Application Publication 2019/0248288 discusses using ground projections to indicate vehicle intentions in autonomous driving scenarios.

The integration of logo projection with advanced driver-assistance systems (ADAS) and vehicle-to-everything (V2X) communication represents an emerging trend, as evidenced by recent patent applications in this area.

However, there remains a significant gap in the market for a projection lamp system that can offer multiple, independently controlled projections without relying on complex mechanical systems or sacrificing image quality. Such a system would provide greater flexibility in logo display, allow for dynamic messaging, and potentially integrate with other vehicle systems for enhanced functionality.

Against this background, there is a need to provide a more developed projection lamp system, that in particular offers multiple, independently controlled projections.

According to a first aspect, a projection lamp assembly and/or an exterior rear-view assembly as defined in the independent claims is/are provided. Advantageous configurations, embodiments and developments emerge from the further dependent claims and from the description with reference to the figures of the drawings.

Thus, the present disclosure provides projection lamp assembly for or mounted on a vehicle, the projection lamp assembly comprising: a casing; a light system having at least two light sources and configured to emit light; at least one lens system each having at least two lenses; and at least one mask system each having at least two masks; wherein the light system, the at least one lens system and the at least one mask system are housed in the casing, and wherein the at least one lens system and the at least one mask system are arranged with regard to the light system and configured such to receive the emitted light from the light system, and to transmit the received light to illuminate at least two projections independent of each other.

In an aspect of the present disclosure, the at least one lens system comprises a first lens system and a second lens system, wherein the first lens system is configured to receive the emitted light from the light system and transmit the received light to the at least one mask system, and the second lens system is configured to receive the transmitted light from the at least one mask system and transmit the received light to illuminate the at least two projections. This may result in independent control of multiple projections allow for unprecedented levels of customization.

In an aspect of the present disclosure, the mask system is embedded with at least one of the at least one lens system, the first lens system, and the second lens system to form a unitary body. This allows blended masks to be used to reduce size and weight of the projection lamp assembly.

In an aspect of the present disclosure, the projection lamp assembly comprises two or more first lens systems and/or two or more second lens systems. In an embodiment of the present disclosure, the first lens system is configured for collimating the light, and/or the second lens system is configured for projecting the light to illuminate the at least two projections.

In an aspect of the present disclosure, each of the at least two projections are illuminated on same location or partially overlapping locations, or different locations. In an embodiment of the present disclosure, each of the at least two lenses, the at least two first lenses and the at least two second lenses comprise the same optics or different optics. In an embodiment of the present disclosure, each of the at least two masks are configured with the same logo or different logos. In an embodiment of the present disclosure, each of the at least two light sources are configured to project a same colour light or a different colour light. In an embodiment of the present disclosure, each of the at least two masks lie at same plane or different planes. In an embodiment of the present disclosure, each of the at least two lenses lie at the same plane or different planes.

In an aspect of the present disclosure, the first lens system and the second lens system are arranged parallel to each other or at an angle to each other. This ability to project multiple logos with different colours and in various locations around the vehicle may add a new dimension to vehicle aesthetics. This feature may significantly enhance the vehicle's visual appeal, especially in low-light environments.

In an aspect of the present disclosure, the at least one lens system is configured to adjust a size or shape of the at least two projections.

In an aspect of the present disclosure, a control unit is provided for controlling the at least two light sources. The control unit is connected to the light system and configured such to control timing, duration, and/or sequence of the light emitted by the at least two light sources.

The present disclosure also provides according to a further aspect an exterior rear-view assembly comprising at least one projection lamp assembly as described in the above sketched embodiments.

Therefore, the present disclosure provides a projection lamp assembly which has ability to project multiple logos simultaneously or alternatively, significantly increases brand exposure. This feature is particularly valuable during vehicle approach, entry, and exit scenarios, reinforcing brand identity for both the vehicle owner and observers. The system's flexibility allows for displaying different aspects of a brand's identity or even co-branding opportunities. Further, multiple projections can serve dual purposes of branding and safety. For instance, the system could project warning symbols or messages to pedestrians or other road users, enhancing vehicle visibility in low-light conditions. This feature becomes increasingly relevant with the advent of electric vehicles, which operate more quietly. The independent control of multiple projections allow for unprecedented levels of customization. Vehicle owners could potentially switch between different logos or messages, personalizing their vehicle's appearance for various occasions or preferences. The projection lamp assembly's connection to a control unit opens up possibilities for integration with other vehicle systems. For example, the logos could change based on driving modes, respond to voice commands, or interact with smartphone apps, enhancing the overall user experience and vehicle connectivity. For fleet vehicles or car-sharing services, the ability to project multiple, changeable logos provides a powerful marketing tool.

Projections could be updated remotely to reflect different campaigns or partnerships without physical modifications to the vehicle. The ability to project multiple projections with different colours and in various locations around the vehicle adds a new dimension to vehicle aesthetics. This feature can significantly enhance the vehicle's visual appeal, especially in low-light environments. With independent control over multiple projections, the system could create dynamic light shows or animated displays. This could be used for special events, celebrations, or even as a unique vehicle locator feature in large parking areas. The advanced lens and mask system allows for clear, sharp projections in various environmental conditions. The ability to adjust projection size and focus enhances functionality across different surfaces and distances. The programmable control unit makes the system highly adaptable to future needs. Logos or projection patterns could be updated to reflect changes in brand identity or to add new functionalities without replacing the entire system. As vehicle technology advances, this projection system could potentially integrate with augmented reality systems, projecting navigation information, vehicle status, or interactive elements onto the surrounding environment. The compact, self-contained design of the assembly allows for easier manufacturing and installation processes. This could lead to cost efficiencies in production and greater flexibility in vehicle design integration. Furthermore, the simplified design of the projection lamp assembly allows a cheaper alternative of the digital light processing (DLP) technology.

The foregoing summary is illustrative only and is not intended to be in any way limiting. In addition to the illustrative aspects, embodiments, and features described above, further aspects, embodiments, and features will become apparent by reference to the drawings and the following detailed description.

It should be understood that any one of the described features and/or embodiments of the disclosure may be used separately or in combination with other disclosed features and/or embodiments.

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

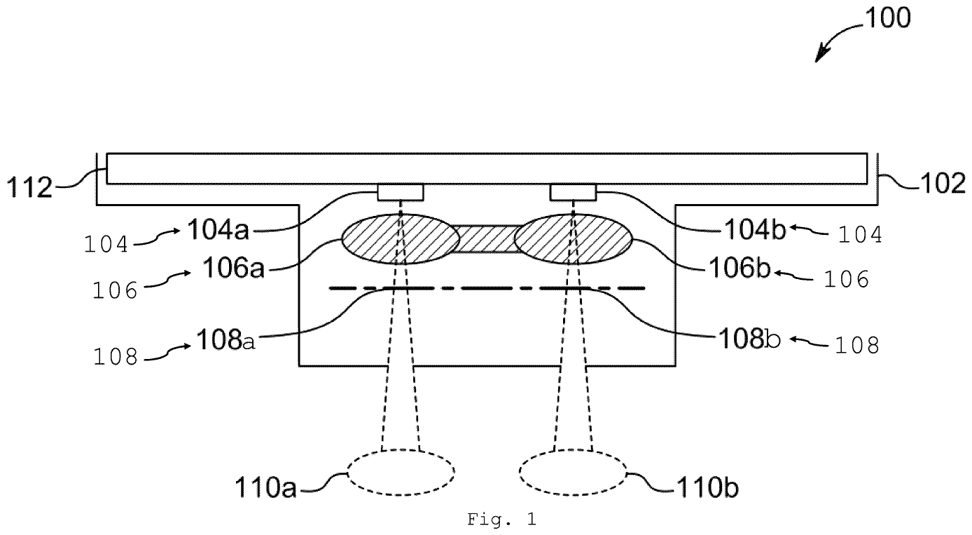

FIG. 1 illustrates a cross-sectional view of a projection lamp assembly with illumination of projections, in accordance with first embodiment of the present disclosure;

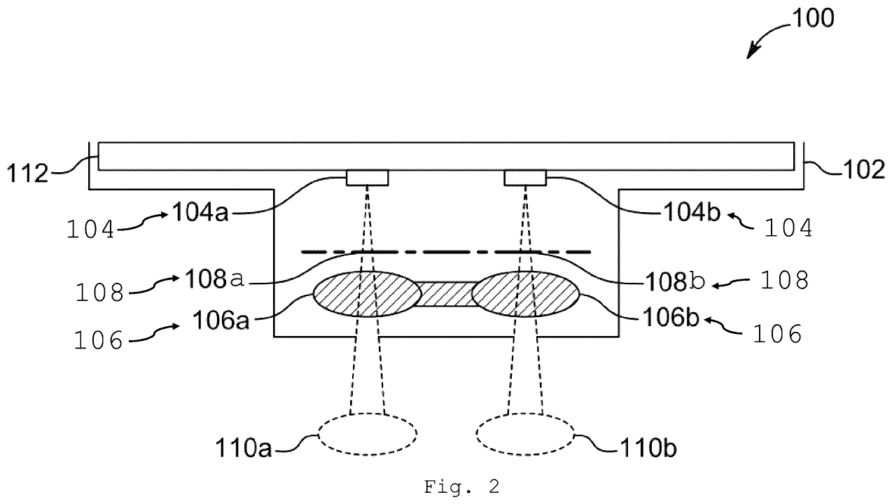

FIG. 2 illustrates a cross-sectional view of a projection lamp assembly with illumination of projections, in accordance with second embodiment of the present disclosure;

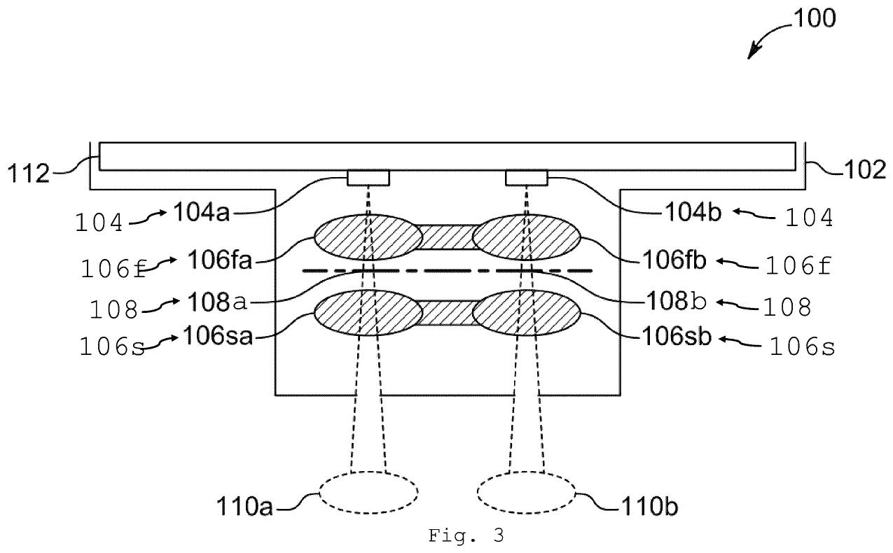

FIG. 3 illustrates a cross-sectional view of a projection lamp assembly with illumination of projections, in accordance with third embodiment of the present disclosure;

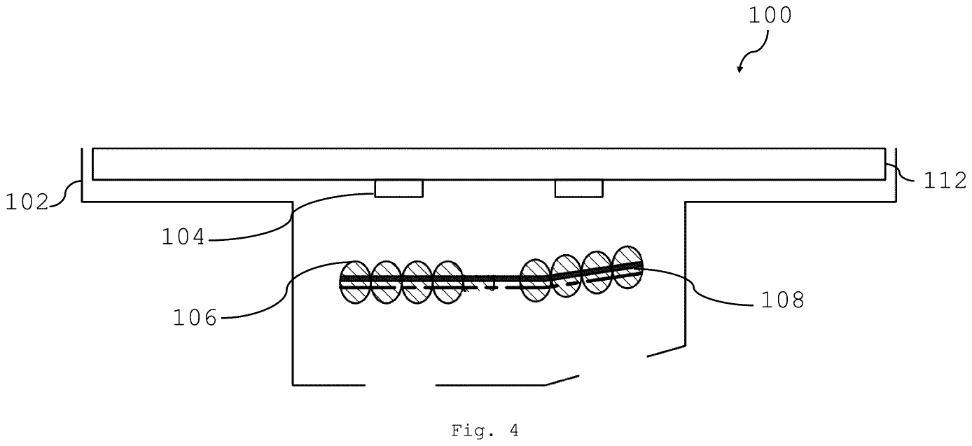

FIG. 4 illustrates a cross-sectional view of a projection lamp assembly, in accordance with yet another embodiment of the present disclosure;

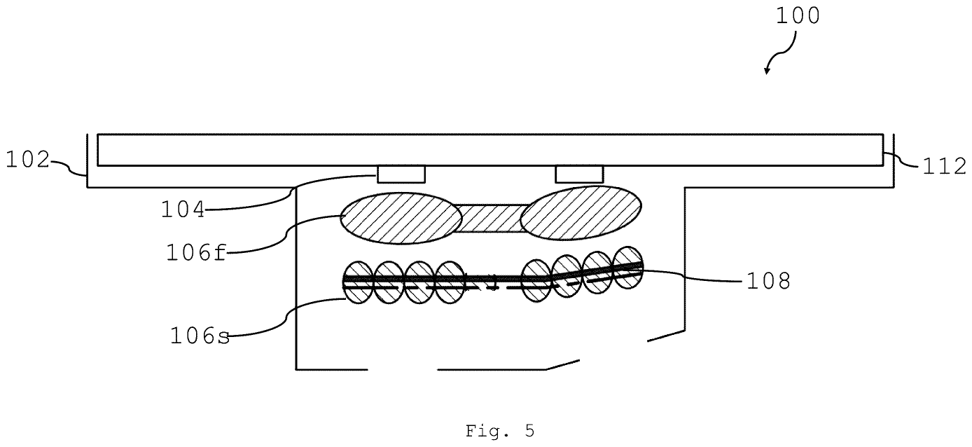

FIG. 5 illustrates a cross-sectional view of a projection lamp assembly, in accordance with yet another embodiment of the present disclosure;

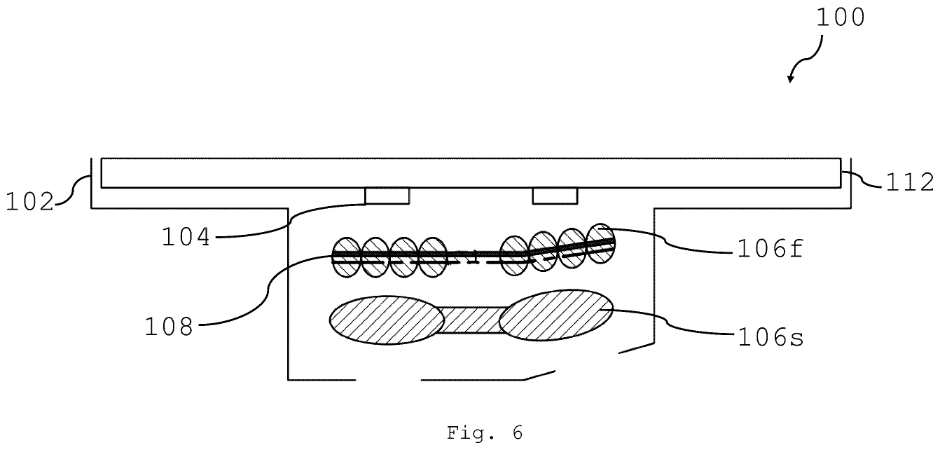

FIG. 6 illustrates a cross-sectional view of a projection lamp assembly, in accordance with yet another embodiment of the present disclosure; and

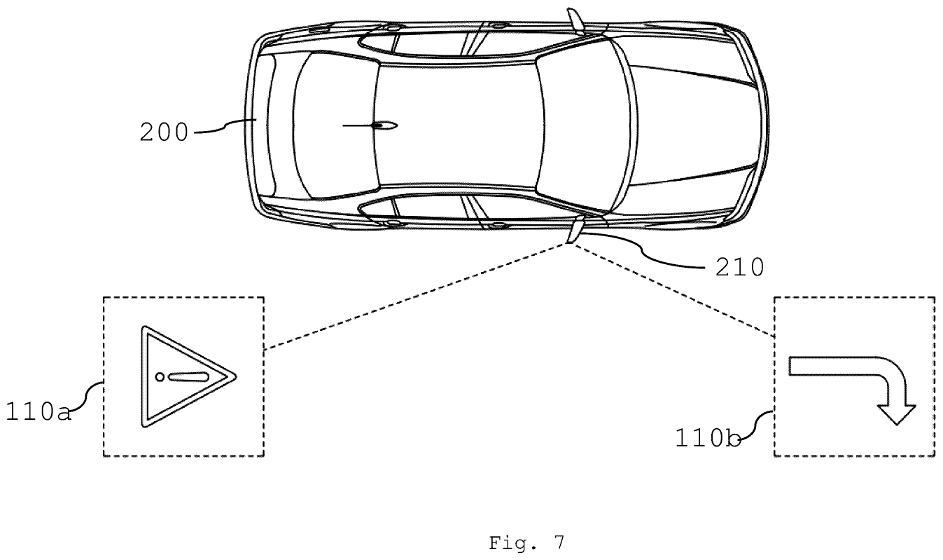

FIG. 7 illustrates a schematic top view of a vehicle with the projection lamp assembly, in accordance with an embodiment of the present disclosure.

The drawings referred to in this description are not to be understood as being drawn to scale except if specifically noted, and such drawings are only exemplary in nature.

The foregoing objects, features and advantages of the present disclosure will become more apparent from the following detailed description related to the accompanying drawings. However, various modifications may be applied to the present disclosure, and the present disclosure may have various embodiments. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, like reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

While the present disclosure is illustrated in the context of a four-wheeled vehicle, however, holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

FIG. 1 illustrates a cross-sectional view of a projection lamp assembly 100 for illumination of at least two projections 110a, 110b in accordance with a first embodiment. The projection lamp assembly 100 may be designed to be compact and easily integrated into various vehicle components, such as exterior rear-view mirrors 210 (as shown in FIG. 7), door panels, bonnet, spoiler, A/B pillar or other suitable locations on a vehicle 200. The projection lamp assembly 100 encompasses a casing 102, a light system 104, at least one lens system 106, at least one mask system 108 and a control unit 112. The casing 102 may be an outer shell or housing of the projection lamp assembly 100. The casing 102 may be configured for enclosing the at least one lens system 106, the at least one mask system 108 and the control unit 112. The casing 102 may provide protection for the internal components and allows for secure mounting to the vehicle 200. The casing 102 is preferably made of a durable, weather-resistant material suitable for automotive applications.

Further, the light system 104 may be configured for emitting light for projection. The light system 104 may comprise of at least two light sources 104a, 104b. Further, each of the two light sources 104a, 104b may be configured to project a same colour light or a different colour light. These light sources are preferably high-efficiency LEDs capable of producing bright, clear illumination. The use of multiple light sources allows for illumination of the at least two projections 110a, 100b, as shown in FIGS. 1-3. Each of the at least two light sources 104a, 104b may be capable of producing white light or could be a multi-colour LED for added versatility.

As shown in FIG. 1, the at least one lens system 106 may be positioned to receive light directly from the light sources 104a, 104b. The at least one lens system 106 may comprise at least two lenses 106a, 106b. Each of the two lenses 106a, 106b may receive the light directly from the light system 104a 104b correspondingly. Further, each of the at least two lenses 106a, 106b may be configured with same optics or different optics. Further, each of the at least two lenses 106a, 106b may lie at same plane or different planes. Further, each of the at least two lenses 106a, 106b may be configured in a same moulding or separate mouldings. Further, each of the at least two lenses 106a, 106b may be configured to transmit and direct the received light towards an intended surface for illumination of at least two projections 110a, 110b (as shown in FIG. 1) through the at least one mask system 108. The intended surface may be at least one of a surface of the vehicle 200 and the ground. Further, the at least one lens system 106 may be configured to adjust a size or shape of the illuminated at least two projections 110a, 110b.

The at least one mask system 108 may comprises at least two masks 108a, 108b. The at least two masks 108a, 108b may have patterns or cut-outs that shape the light to form the desired logo or image. Each of the at least two masks 108a, 108b may made of a thin, opaque material with transparent sections forming the desired logo or image shape. Each of the at least two masks 108a, 108b may be designed to create a specific logo or image. In an embodiment, each of the at least two masks 108a, 108b may be configured with a same logo or different logos. Further, each of the at least two masks 108a, 108b lie at same plane or different planes. Further, each of the at least two masks 108a, 108b may be configured in a same moulding or separate mouldings. The at least two masks 108a, 108b may receive the light from the at least two lens 106a, 106b correspondingly. The use of multiple masks allows for different logos to be projected simultaneously or alternately, depending on the control scheme employed. Further, each of the at least two masks 108a, 108b may be held by a substrate which acts as a base material or structure used to hold or support the at least two masks 108a, 108b within the mask system 108.

The light path through the projection lamp assembly 100 is indicated by dotted lines in FIG. 1. Light emitted from the sources 104a, 104b first passes through the lens system 106. Further, the light encounters the mask system 108. Finally, the light projects out of the projection lamp assembly 100 to get projected on to the intended surface as distinct at least two projections 110a, 110b. Further, the each of the at least two projections 110a, 110b may be illuminated on same location or partially overlapping locations, or different locations. FIGS. 1-3 show illumination of the at least two projections 110a, 110b at different locations. However, illumination may be partially overlapping or on same location based on optical property of the lens system 106 and geometrical shape of the casing 102.

Additionally, the control unit 112 is electronically connected to the light system 104. The control unit 112 may be configured to manage the operation of each of the two light sources 104a, 104b, controlling factors such as illumination timing, duration, and intensity. The control unit 112 may be programmed to create various lighting scenarios, such as alternating between logos, simultaneous logo projection, or coordinating logo projection with other vehicle events (e.g., door opening, vehicle locking/unlocking). The projection lamp assembly 100 is designed for versatility and can be adapted for various projection scenarios.

FIG. 2 illustrates a cross-sectional view of a projection lamp assembly 100 with illumination of at least two projections 110a, 110b in accordance with a second embodiment. The projection lamp assembly 100 encompasses, as described for the first embodiment, the casing 102, the light system 104, the at least one lens system 106, the at least one mask system 108 and the control unit 112. However, the at least one mask system 108 may configured to receive light directly from the light system 104. More particularly, the at least two masks 108a, 108b may be configured to receive light directly from each of the at least two sources 104a, 104b correspondingly. Further, the light travels through the each of the at least two masks 108a, 108b to reach the lens system 106. More particularly, the light travels through the at least two masks 108a, 108b to reach the at least two lenses 106a, 106b correspondingly which focuses the images and projects them out of the projection lamp assembly 100 as distinct at least two projection 110a, 110b on the intended surface.

FIG. 3 illustrates a cross-sectional view of a projection lamp assembly 100 with illumination of at least two projections 110a, 110b in accordance with a third embodiment. The projection lamp assembly 100 encompasses, the casing 102, the light system 104, the at least one lens system 106, the at least one mask system 108 and the control unit 112. However, the at least one lens system 106 comprises a first lens system 106f and a second lens system 106s. The first lens system 106f and the second lens system 106s may be parallel or at an angle to each other. The first lens system 106f has at least two first lenses 106fa, 106fb, and the second lens system 106s has at least two second lenses 106sa, 106sb. Further, each of the two first lenses 106fa, 106fb and each of the two second lenses 106sa, 106sb may be configured with same optics or different optics. Further, each of the two first lenses 106fa, 106fb and each of the two second lenses 106sa, 106sb may be parallel or at an angle to each other. Further, each of the two first lenses 106fa, 106fb and each of the two second lenses 106sa, 106sb may be configured in a same moulding or separate mouldings.

The at least two first lenses 106fa, 106fb of first lens system 106f may be positioned to receive light directly from the light sources 104a, 104b correspondingly. The primary function of the first lens system 106f is to collimate the light, creating parallel light rays for improved image clarity. Further, the at least two masks 108a, 108b of the at least one mask system 108 may be positioned to receive light directly from the at least two first lenses 106fa, 106fb correspondingly. Furthermore, the second lens system 106s is located further along the light path, after the mask system 108. More particularly, each of the at least two second lenses 106sa, 106sb may be configured to receive the transmitted light from the at least two masks 108a, 108b correspondingly. The at least two second lenses 106sa, 106sb may focus the light onto the intended surface to illuminate the at least two projections 110a, 110b.

FIGS. 4-6 illustrates a cross-sectional view of a projection lamp assembly 100 in accordance with various possible embodiments, wherein the mask system 108 and at least one of the at least one lens system 106, the first lens system 106f, and the second lens system 106s may be blended to form a unitary body. In other words, wherein the mask system 108 may be embedded with at least one of the at least one lens system 106, the first lens system 106f, and the second lens system 106s to form the unitary body.

Therefore, the present disclosure provides the projection lamp assembly 100 configured to project at least two projections 110a, 110b. However, in another embodiment, the projection lamp assembly 100 may comprise a mask system 108 with three masks and a lens system 106 with three lenses to project three projections. In yet another embodiment, the projection lamp assembly 100 may comprise a mask system 108 with four masks and a lens system 106 with four lenses to project four projections. Further, in an embodiment, the projection lamp assembly 100 may comprise two or more first lens systems 106f. In yet another embodiment, the projection lamp assembly 100 may comprise two or more second lens systems 106s.

Further, as illustrated in FIG. 7, the projection lamp assembly 100 may be mounted on an exterior rear-view mirror 210 of the vehicle 200 allowing for projections on a side of the vehicle 200. The at least two projections 110a, 110b may be displayed on the ground adjacent to the vehicle, on nearby walls, or even on the vehicle's body itself, depending on the specific installation and lens configuration. The ability to project multiple, independent projections opens up new possibilities for brand communication, safety features, and personalized vehicle lighting. In operation, when activated (for example, when the vehicle is unlocked), the control unit 112 signals the light sources 104a, 104b to emit the light. The light passes through the optical systems described above, resulting in the clear, distinct projections 110a, 110b in the desired locations around the vehicle. The system's flexibility allows for various projection scenarios, from simple static logos to more complex, dynamic lighting displays, enhancing both the aesthetic appeal and functionality of the vehicle's exterior lighting system.

The present disclosure addresses these limitations and market needs by introducing a novel projection lamp assembly capable of projecting multiple, independently controlled projections. The present disclosure represents a significant step forward in projection technology, offering improved versatility, functionality, and potential for integration with other vehicle systems.

It will be appreciated by those skilled in the art that changes could be made to the embodiments described above without departing from the broad inventive concept thereof. It is understood, therefore, that the invention disclosed herein is not limited to the particular embodiments disclosed and is intended to cover modifications within the spirit and scope of the present invention.

### LIST OF REFERENCES

100 Projection lamp assembly
102 Casing
104 Light system
104a, 104b light sources
106 Lens system
106a, 106b Lenses
106f First lens system
106fa, 106fb first lenses
106s Second lens system
106sa, 106sb second lenses
108 Mask system
108a, 108b masks
110a, 100b projections
112 Control system
200 Vehicle
210 Exterior rear-view mirror

1. A projection lamp assembly for or mounted on a vehicle, the projection lamp assembly comprising:
a casing;
a light system having at least two light sources and configured to emit light;
at least one lens system each having at least two lenses; and
at least one mask system each having at least two masks;
wherein the light system, the at least one lens system and the at least one mask system are housed in the casing, and
wherein the at least one lens system and the at least one mask system are arranged with regard to the light system and configured such to
receive the emitted light from the light system, and
transmit the received light to illuminate at least two projections independent of each other.

2. The projection lamp assembly of claim 1, wherein the at least one lens system comprises a first lens system and a second lens system, wherein:
the first lens system is configured to receive the emitted light from the light system and transmit the received light to the at least one mask system, and
the second lens system is configured to receive the transmitted light from the at least one mask system and transmit the received light to illuminate the at least two projections.

3. The projection lamp assembly of claim 2, wherein the mask system is embedded with at least one of the at least one lens system, the first lens system, and the second lens system to form a unitary body.

4. The projection lamp assembly of claim 2, wherein the first lens system is configured for collimating the light.

5. The projection lamp assembly of claim 2, wherein the second lens system is configured for projecting the light to illuminate the at least two projections.

6. The projection lamp assembly of claim 2, wherein the projection lamp assembly comprises two or more first lens systems.

7. The projection lamp assembly of claim 2, wherein the projection lamp assembly comprises two or more second lens systems.

8. The projection lamp assembly of claim 1, wherein each of the at least two projections are illuminated on the same location or on partially overlapping locations, or on different locations.

9. The projection lamp assembly of claim 1, wherein each of the at least two lenses, the first lens system and the second lens system comprise the same optics or different optics.

10. The projection lamp assembly of claim 1, wherein each of the at least two masks comprise the same logo or different logos.

11. The projection lamp assembly of claim 1, wherein each of the at least two light sources are configured to project the same colour light or a different colour light.

12. The projection lamp assembly of claim 1, wherein the projection lamp assembly is configured to illuminate the at least two projections on at least one surface of the vehicle.

13. The projection lamp assembly of claim 1, wherein the projection lamp assembly is configured to illuminate the at least two projections on the ground surface.

14. The projection lamp assembly of claim 1, wherein each of the at least two masks lie at the same plane or different planes.

15. The projection lamp assembly of claim 1, wherein each of the at least two lenses lie at the same plane or different planes.

16. The projection lamp assembly of claim 1, wherein the first lens system and the second lens system are arranged parallel to each other or at an angle to each other.

17. The projection lamp assembly of claim 1, wherein the at least one lens system is configured to adjust a size or shape of the at least two projections.

18. The projection lamp assembly of claim 1, further comprising a control unit for controlling the at least two light sources, wherein the control unit is connected to the light system and is configured such to control at least one of timing, duration, and sequence of the light emitted by the at least two light sources.

19. An exterior rear-view assembly for a vehicle, the exterior rear-view assembly comprising at least one projection lamp assembly projection lamp assembly, the projection lamp assembly comprising:
a casing;
a light system having at least two light sources and configured to emit light;
at least one lens system each having at least two lenses; and
at least one mask system each having at least two masks;
wherein the light system, the at least one lens system and the at least one mask system are housed in the casing, and
wherein the at least one lens system and the at least one mask system are arranged with regard to the light system and configured such to
receive the emitted light from the light system, and
transmit the received light to illuminate at least two projections independent of each other.
